(19) United States
(12) Patent Application Publication
(10) Pub. No.: US 2011/0017030 A1
(43) Pub. Date: Jan. 27, 2011

(54) UNIVERSAL CUTTING TOOL FOR USE WITH LEGACY AND NEW GENERATION EXPLOSIVE ORDINANCE DISPOSAL (EOD) ROBOTS

(76) Inventor: Paul Chambers, Harvard, MA (US)

Correspondence Address: Mark J. Pandiscio;Pandiscio & Pandiscio, P.C., 470 Totten Pond Road, Waltham, MA, 02451-1914, US

(21) Appl. No.: 12/689,876

(22) Filed: Jan. 19, 2010

Related U.S. Application Data
(60) Provisional application No. 61/205,291, filed on Jan. 16, 2009.

(51) Int. Cl. B24B 27/08; B24B 55/00; B24B 23/02; B26D 7/26

(52) U.S. Cl. 83/13; 451/415; 451/457; 83/522.12

(57) ABSTRACT

A universal cutting tool for use on the arm of a robot, the universal cutting tool comprising:
a cutter head comprising a housing adapted for attachment to the arm of a robot, an electric motor secured to the housing and comprising a drive shaft, and a grinding wheel connected to the drive shaft;
a power supply; and
control electronics for operating the electric motor, the control electronics connecting the power supply to the motor;
wherein the control electronics are adapted to monitor the level of current drawn by the electric motor and to monitor the speed of rotation of the drive shaft.

### REFERENCE TO PENDING PRIOR PATENT APPLICATION

This patent application claims benefit of pending prior U.S. Provisional Patent Application Ser. No. 61/205,291, filed Jan. 16, 2009 by Paul Chambers for UNIVERSAL CUTTING SYSTEM (Attorney's Docket No. CHAMB-16 PROV), which patent application is hereby incorporated herein by reference.

### FIELD OF THE INVENTION

This invention relates to cutting apparatus in general, and more particularly to powered cutting tools for use with both legacy and new generation explosive ordinance disposal (EOD) robots.

### BACKGROUND OF THE INVENTION

Explosive ordinance disposal (EOD) robots are well known in the art. In general, these robots are remotely-controlled vehicles which are used to approach potentially hazardous materials (e.g., explosive ordinance) so that the materials can be investigated and/or disposed of while an operator remains at a safe distance from those materials. To this end, EOD robots are typically configured with an on-board camera to permit the operator to maneuver the robot and to view the potentially hazardous materials, and one or more arms (including grippers) to permit the operator to remotely manipulate the potentially hazardous materials.

In some circumstances, it may be necessary or desirable for the EOD robot to cut through an object. By way of example but not limitation, the EOD robot may need to separate an explosive vest from a hostage, or to cut through a cable to permit the robot to gain entry into a restricted area, etc. To this end, it is desirable to provide a powered cutting tool for use with EOD robots, where the powered cutting tool is capable of cutting through a wide range of different objects, e.g., cloth, ballistic nylons, mixed textiles with zippers, buckles or chain, key shanks, cable, chain, sheet metal, etc. In addition, since there are already a large number of EOD robots deployed in the field, it is desirable for the powered cutting tool to be usable with both legacy robots as well as with new generation robots, which in turn requires that the powered cutting tool be “self-contained” in the sense that the powered cutting tool contains its own power supply and control electronics, and in the sense that the powered cutting tool can be mechanically mounted to substantially any existing EOD robot.

### SUMMARY OF THE INVENTION

These and other objects are addressed by the present invention, which comprises the provision and use of a novel universal cutting tool for use with both legacy and new generation explosive ordinance disposal (EOD) robots. More particularly, the universal cutting tool comprises a cutter head that is designed to cut through cloth, ballistic nylons, mixed textiles with zippers, buckles or chain, key shanks, cables, chains, sheet metal, etc., all with a single tool. A shoe-guide prevents damage to any surface adjacent to the object being cut, which can be particularly important in hostage cases where an explosive package must be cut off the hostage in order to alleviate the danger. The universal cutting tool comprises its own control electronics which include a closed-loop feedback control system which monitors the current and voltage draw of the cutter head in order to prevent jamming. This anti-jamming feature not only works to prevent a mission-ending lock-up, but it also works to save the cutter head from possible electrical burnout in the event of a jam. The closed-loop feedback control system also minimizes power draw when the universal cutting tool is in its “idle” mode. This idle feature extends battery life, and therefore mission life, by as much as 500%. In one preferred form of the invention, only the cutter head is mounted on the robot arm, with the remainder of the universal cutting tool being mounted on the chassis of the robot, thereby providing a light tip load and low physical profile. This is significant, in view of the substantial arm extensions provided with some EOD robots, and in view of the need to avoid obstructing operator view and/or other robot functions. With the remainder of the universal cutting tool (i.e., the battery and control electronics) being located on the robot deck, proper vehicle balance is maintained and a major portion of the universal cutting tool stands clear of the operator's field of view and various robot functions (such as gripper movement or disrupter line of fire). The universal cutting tool can be turned on or off by engaging a push switch (e.g., a bump switch) located on the universal cutting tool, or the universal cutting tool can be activated by connecting the universal cutting tool into one of the accessory ports traditionally provided on EOD robots. The universal cutting tool is otherwise independent of the robot control system and does not require any additional software or control interfaces with the robot, and the universal cutting tool is positioned by the robot operator using standard robot controls, thereby facilitating use of the universal cutting tool with both legacy robots as well as with new generation robots. In one preferred form of the invention, indicator lights are provided on the housing of the universal cutting tool so as to visually inform the operator (through the robot's existing on-board cameras) of the universal cutting tool's current status, e.g., whether the cutter head is idling, cutting, or about to stall. The control electronics are configured so that if the cutter head stalls, it automatically reverses itself and begins again. The cutter head speeds and torque thresholds can be optimized for cutting through different objects by means of an external switch.

Among other things, the present invention includes the following novel features: (i) a bump on/off switch (the bump switch can be pressed against the ground, or pressed against a gripper element, etc. in order to activate the cutter head); (ii) a pistol grip mount for engagement by robot grippers—the pistol grip is essentially universal in nature, thereby enabling the universal cutting tool to be set down by the robot and then picked up again, so that there is no longer any need to dedicate a robot mount for the universal cutting tool; (iii) a “smart power” feature which responds to motor load in order to provide anti-jamming protection and maximize battery life; (iv) a shoe-guide to protect an adjacent surface while cutting is under way (e.g., to protect a human hostage wearing an explosive vest); (v) an LED feedback system mounted on the housing of the universal cutting tool, to visually provide the operator with operational information visible in the robot's viewfinder (e.g., a lit yellow LED=idle mode, ready to cut, a lit green LED=cutter head cutting within normal power band, a lit red LED=cutter head operating outside normal power band, etc.); and (vi) a cutting tool which is completely independent of the power and control systems of the EOD robot (i.e., separate power, separate controls, etc.), thereby facilitating use of the cutting tool with both legacy EOD robots as well as with new generation EOD robots.

In one preferred form of the invention, there is provided a universal cutting tool for use on the arm of a robot, the universal cutting tool comprising:

a cutter head comprising a housing adapted for attachment to the arm of a robot, an electric motor secured to the housing and comprising a drive shaft, and a grinding wheel connected to the drive shaft;

a power supply; and

control electronics for operating the electric motor, the control electronics connecting the power supply to the motor;

the control electronics comprising a bump switch for turning the electric motor on and off.

In another form of the invention, there is provided a universal cutting tool for use on the arm of a robot, the universal cutting tool comprising:

a cutter head comprising a housing adapted for attachment to the arm of a robot, an electric motor secured to the housing and comprising a drive shaft, and a grinding wheel connected to the drive shaft;

a power supply; and

control electronics for operating the electric motor, the control electronics connecting the power supply to the motor;

the housing comprising a pistol grip adapted to be gripped by the arm of the robot.

In another form of the invention, there is provided a universal cutting tool for use on the arm of a robot, the universal cutting tool comprising:

a cutter head comprising a housing adapted for attachment to the arm of a robot, an electric motor secured to the housing and comprising a drive shaft, and a grinding wheel connected to the drive shaft;

a power supply; and

control electronics for operating the electric motor, the control electronics connecting the power supply to the motor;

the cutter head further comprising a shoe-guide disposed adjacent to, but displaced from, at least a portion of the periphery of the grinding wheel so as to protect an adjacent surface while the grinding wheel is cutting an object.

In another form of the invention, there is provided a universal cutting tool for use on the arm of a robot, the universal cutting tool comprising:

a cutter head comprising a housing adapted for attachment to the arm of a robot, an electric motor secured to the housing and comprising a drive shaft, and a grinding wheel connected to the drive shaft;

a power supply; and

control electronics for operating the electric motor, the control electronics connecting the power supply to the motor;

the control electronics comprising at least one visual indicator mounted to the housing for visually advising the robot operator of the operating status of the cutter head.

In another form of the invention, there is provided a universal cutting tool for use on the arm of a robot, the universal cutting tool comprising:

a cutter head comprising a housing adapted for attachment to the arm of a robot, an electric motor secured to the housing and comprising a drive shaft, and a grinding wheel connected to the drive shaft;

a power supply; and

control electronics for operating the electric motor, the control electronics connecting the power supply to the motor;

wherein the power supply is separate from the robot power supply and further wherein the control electronics are separate from robot control electronics.

In another form of the invention, there is provided a universal cutting tool for use on the arm of a robot, the universal cutting tool comprising:

a cutter head comprising a housing adapted for attachment to the arm of a robot, an electric motor secured to the housing and comprising a drive shaft, and a grinding wheel connected to the drive shaft;

a power supply; and

control electronics for operating the electric motor, the control electronics connecting the power supply to the motor;

wherein the control electronics are adapted to monitor the level of current drawn by the electric motor and to monitor the speed of rotation of the drive shaft.

In another form of the invention, there is provided a method for cutting an object, the method comprising:

providing a universal cutting tool for use on the arm of a robot, the universal cutting tool comprising:
a cutter head comprising a housing adapted for attachment to the arm of a robot, an electric motor secured to the housing and comprising a drive shaft, and a grinding wheel connected to the drive shaft;
a power supply; and
control electronics for operating the electric motor, the control electronics connecting the power supply to the motor;
wherein the control electronics are adapted to monitor the level of current drawn by the electric motor and to monitor the speed of rotation of the drive shaft;

mounting the cutter head to the arm of the robot;

operating the electric motor in idle mode so that the drive shaft has a slow rate of revolution;

engaging the object which is to be cut with the grinding wheel;

when the rate of rotation of the grinding wheel falls and the current draw on the motor rises, raising the power applied to the electric motor so that the motor's revolutions per minute increases;

if and when the level of power being drawn exceeds a predetermined level, providing an alert to an operator; and

if and when the revolutions per minute of the motor thereafter stops, reversing the direction of the motor.

### BRIEF DESCRIPTION OF THE DRAWINGS

These and other objects and features of the present invention will be more fully disclosed or rendered obvious by the following detailed description of the preferred embodiments of the invention, which is to be considered together with the accompanying drawings wherein like numbers refer to like parts, and further wherein:

FIGS. 1-3 are schematic views showing an EOD robot having a novel universal cutting tool mounted thereto;

FIGS. 4-6 are schematic views showing the novel universal cutting tool of FIGS. 1-3;

FIGS. 7-16 are schematic views showing construction details of the cutter head of the universal cutting tool shown in FIGS. 4-6;

FIGS. 17-19 are schematic views showing details of the control electronics of the universal cutting tool of FIGS. 4-6;

FIG. 20 is a schematic view showing the universal cutting tool as seen through the viewfinder of an EOD robot carrying the universal cutting tool;

FIG. 21 is a schematic view showing the universal cutting tool of FIGS. 4-6 cutting through an object;

FIGS. 22-27 are schematic views showing some (but not all) of the objects which can be cut by the universal cutting tool of FIGS. 4-6;

FIG. 28 is a schematic view showing a bump switch which may be used to turn the universal cutting tool on and off;

FIGS. 29-31 are schematic views showing the universal cutting tool equipped with a pistol grip; and

FIG. 32 is a schematic view showing how the control electronics may be integrated with the power supply.

### DETAILED DESCRIPTION OF THE INVENTION

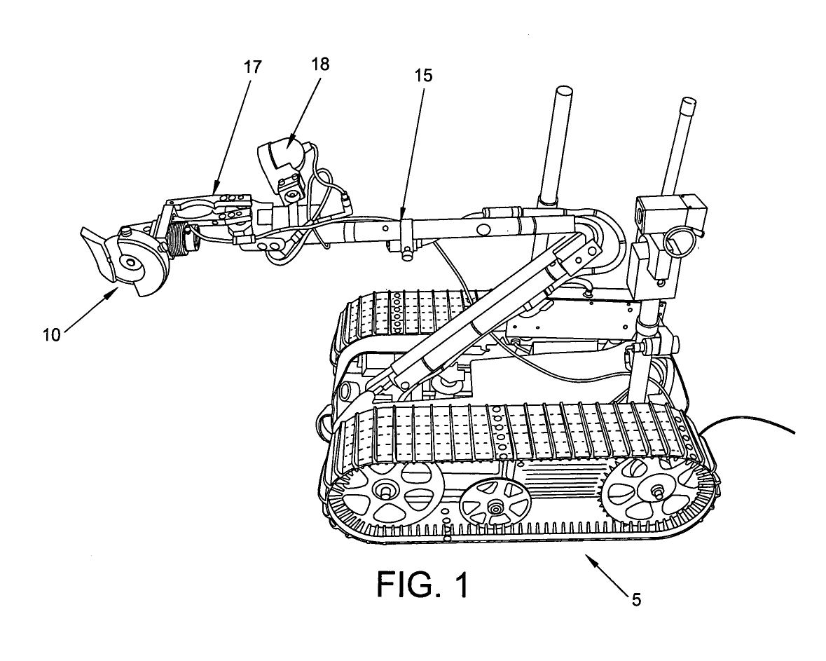

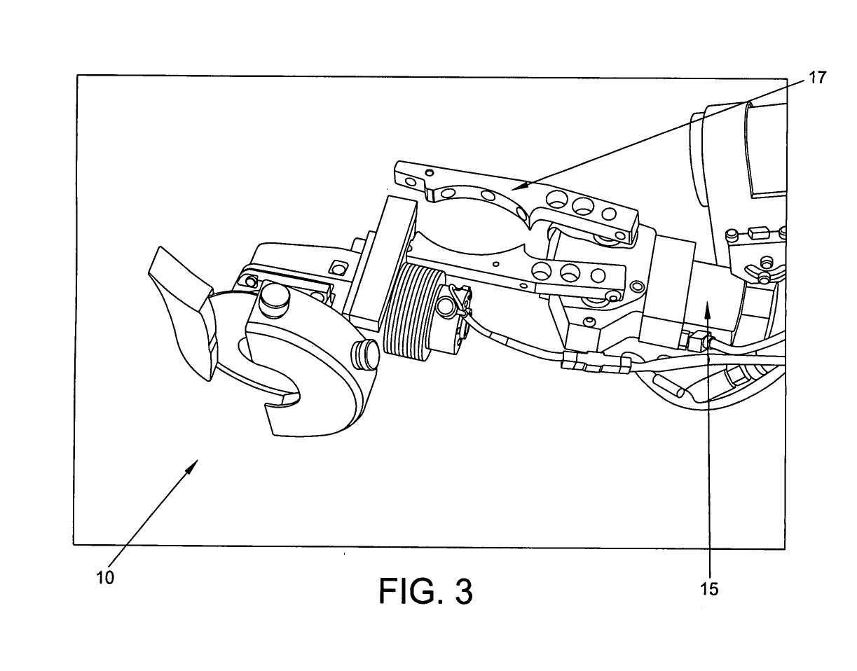

Looking first at FIGS. 1-3, there is shown an explosive ordinance disposal (EOD) robot 5 having a novel universal cutting tool 10 carried by the robot's arm 15 (e.g., by grippers 17 located at the distal end of arm 15). As is well known in the art, the remote-control robot includes an on-board camera system 18 and is operated by an operator using control panel 20 which includes operator controls 21 and a camera display 22. Control panel 20 allows the operator to remotely maneuver EOD robot 5 and, among other things, control its arm 15 (including grippers 17) so as to enable the operator to remotely investigate and/or dispose of potentially hazardous materials. Novel universal cutting tool 10 provides EOD robot 5 with the ability to cut through a wide range of objects (e.g., cloth, ballistic nylons, mixed textiles with zippers, buckles or chain, key shanks, cables, chains, sheet metal, etc.). This cutting ability can be used, for example, to separate an explosive vest from a hostage, to cut through a cable to permit the EOD robot to gain entry into a restricted area, etc.

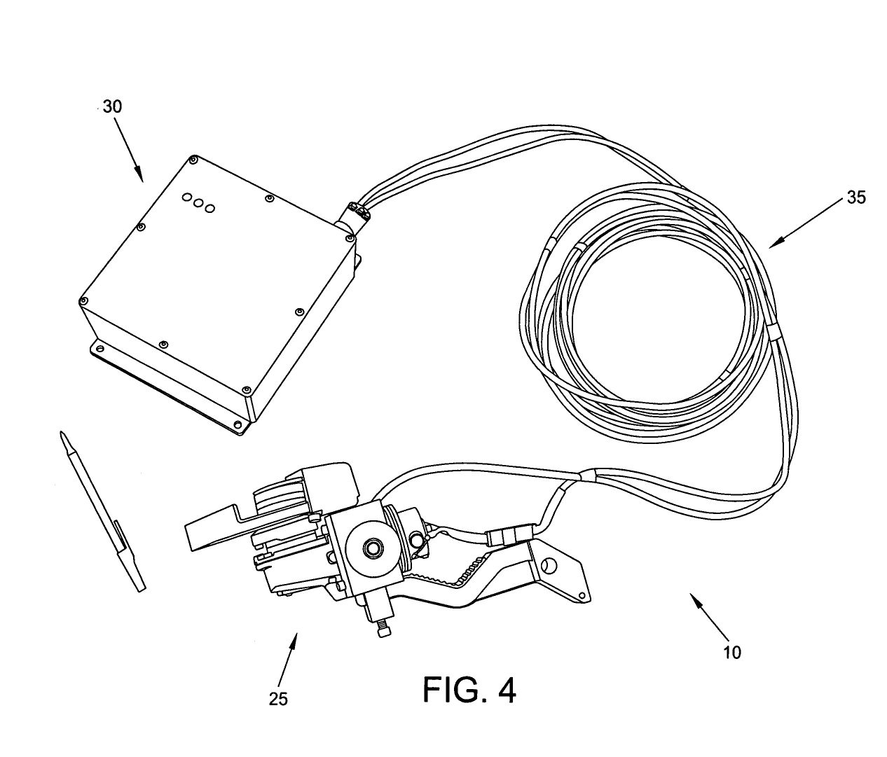

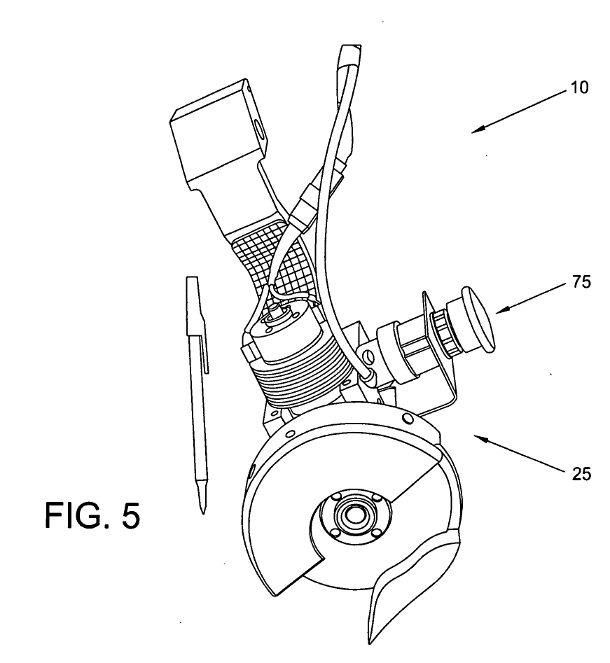

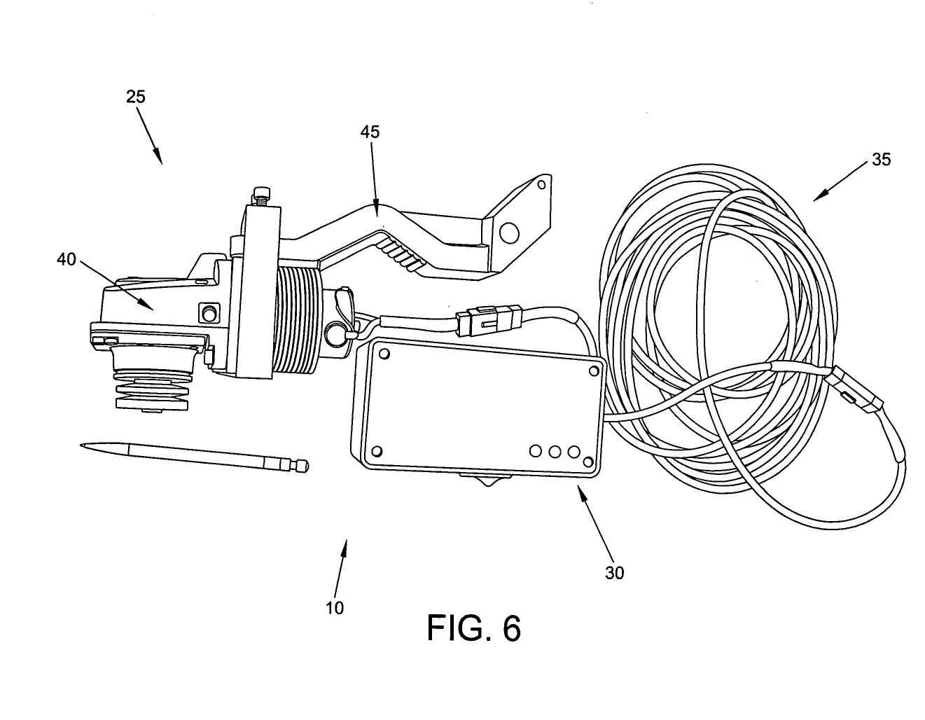

Looking next at FIGS. 4-6, universal cutting tool 10 generally comprises a cutter head 25, a power supply 30, and a cable 35 connecting power supply 30 to cutter head 25.

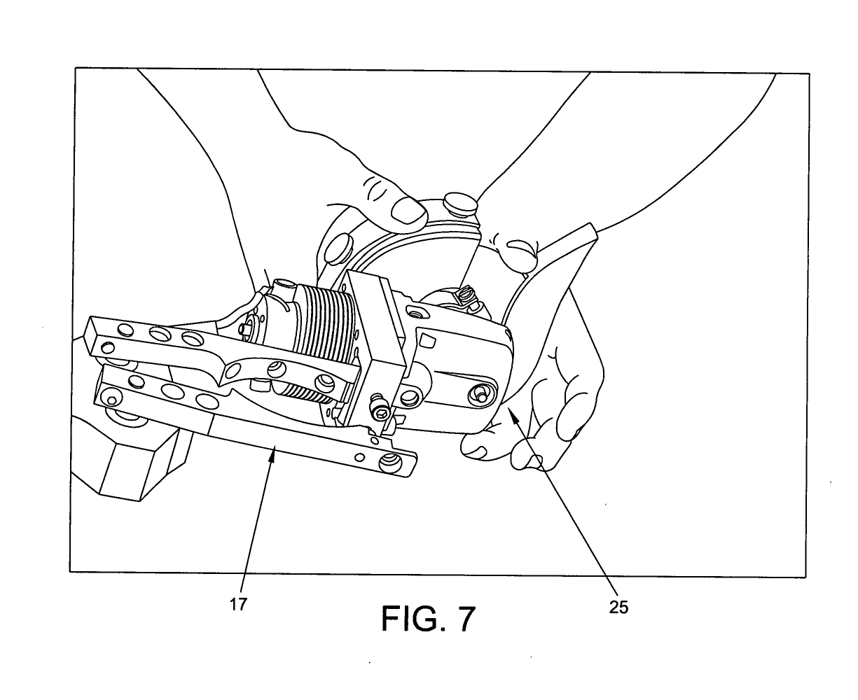

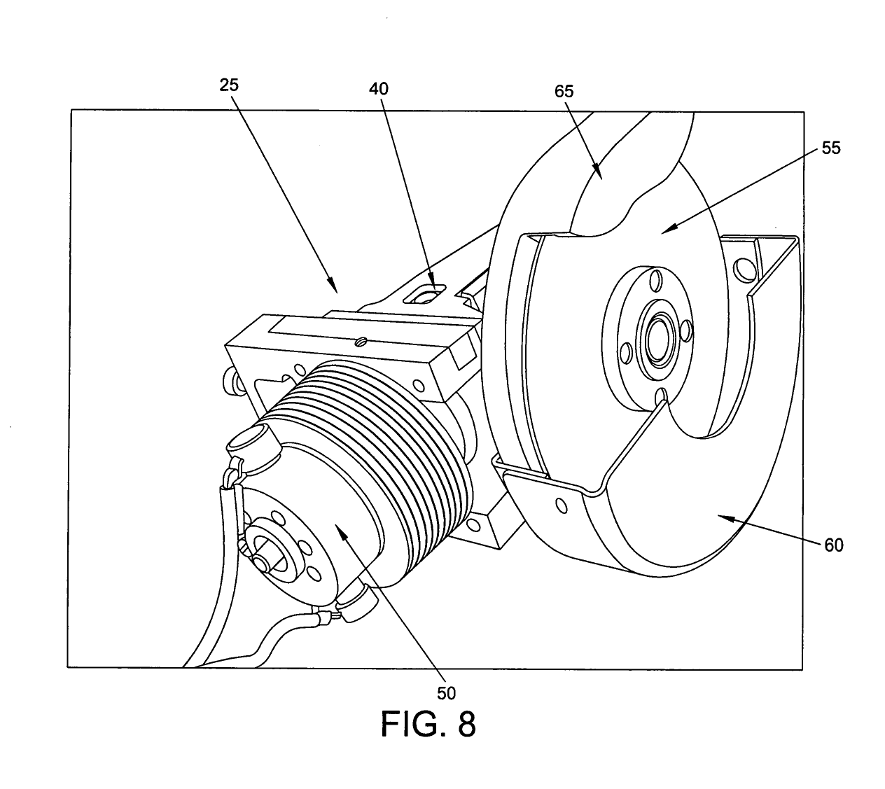

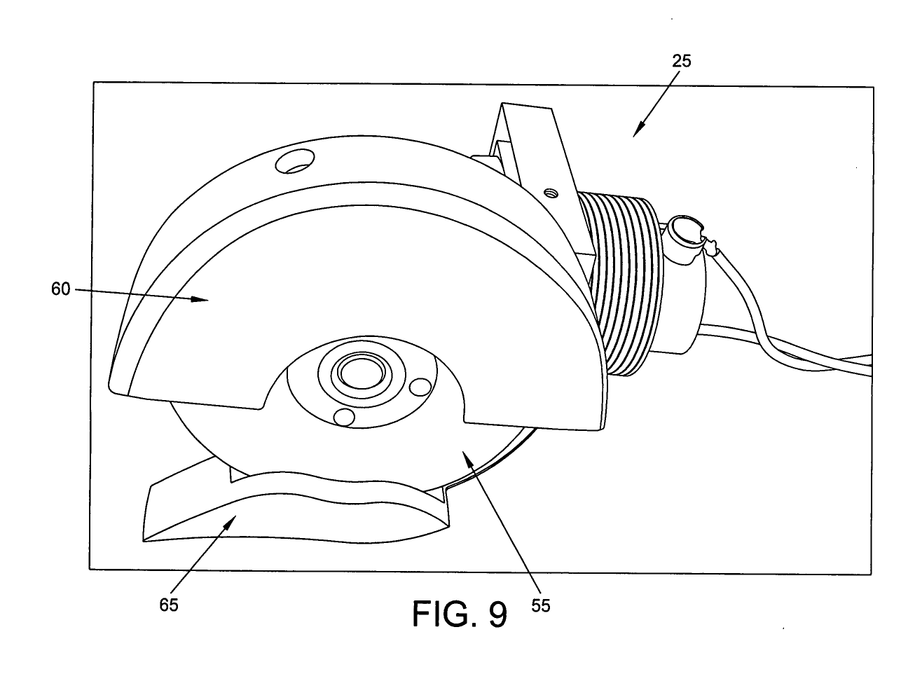

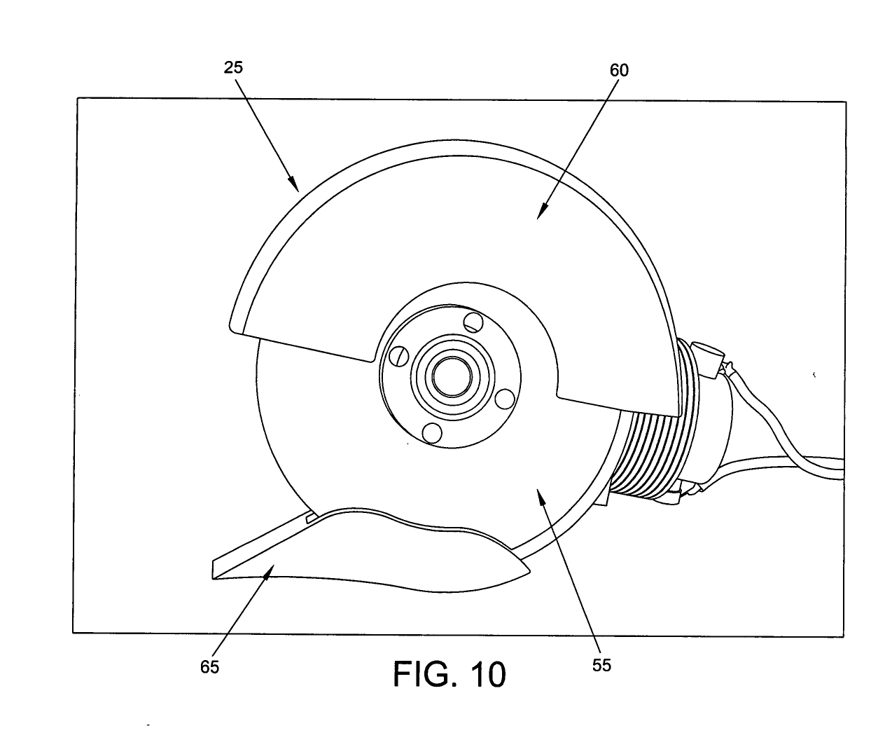

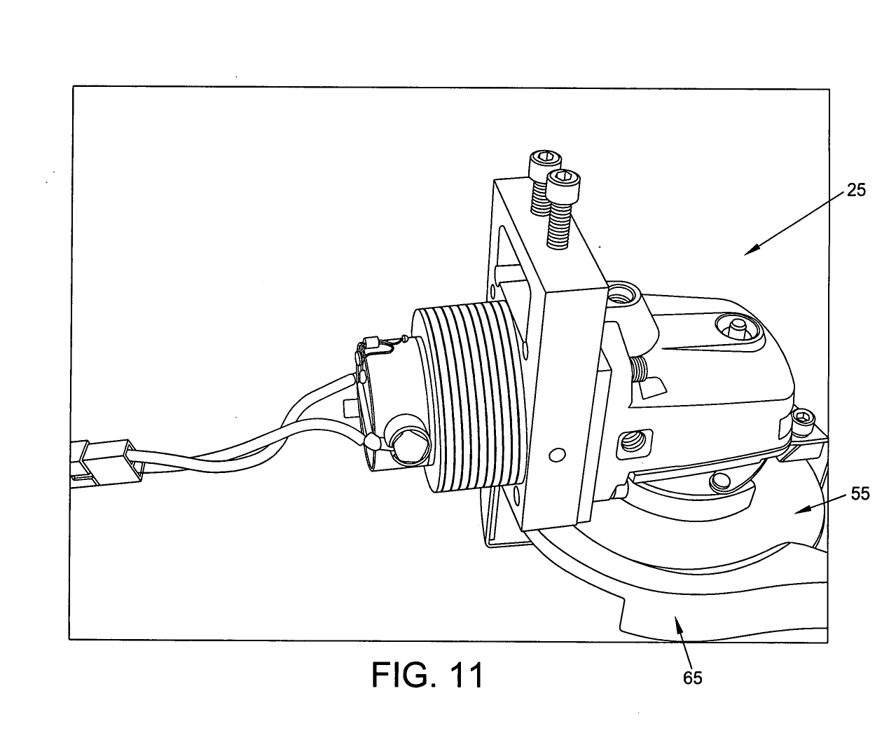

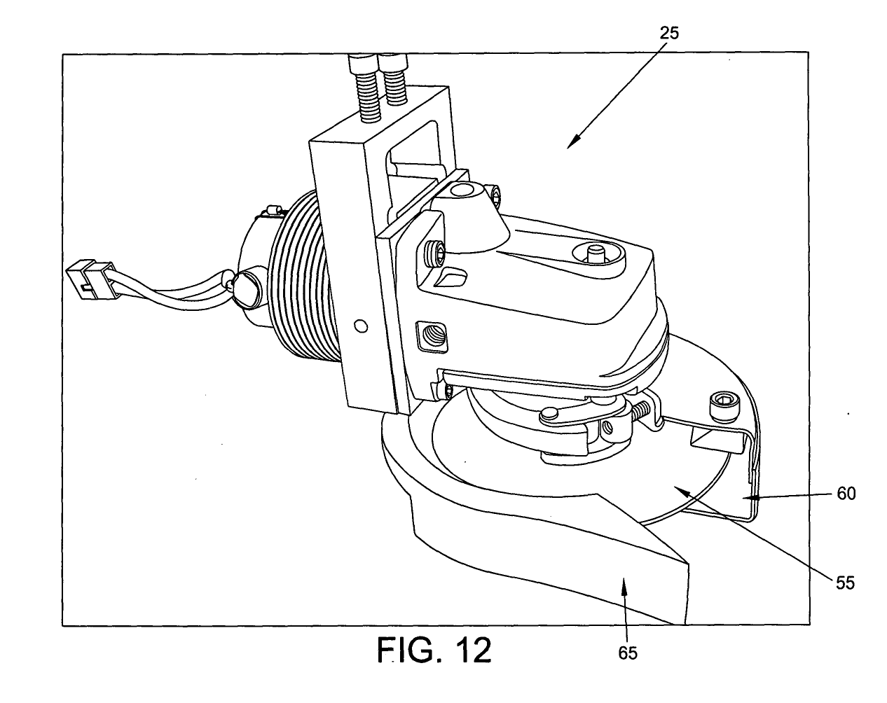

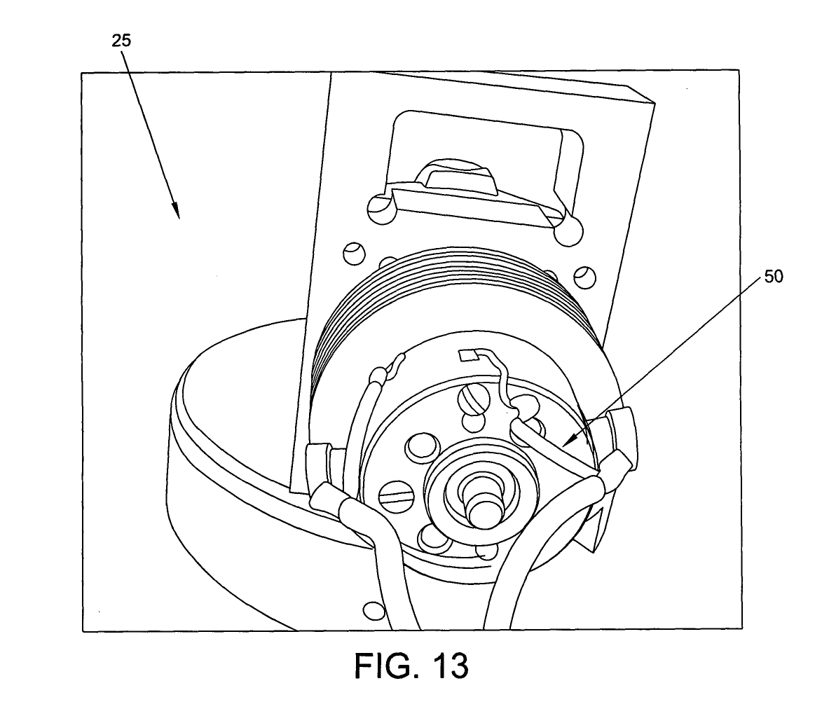

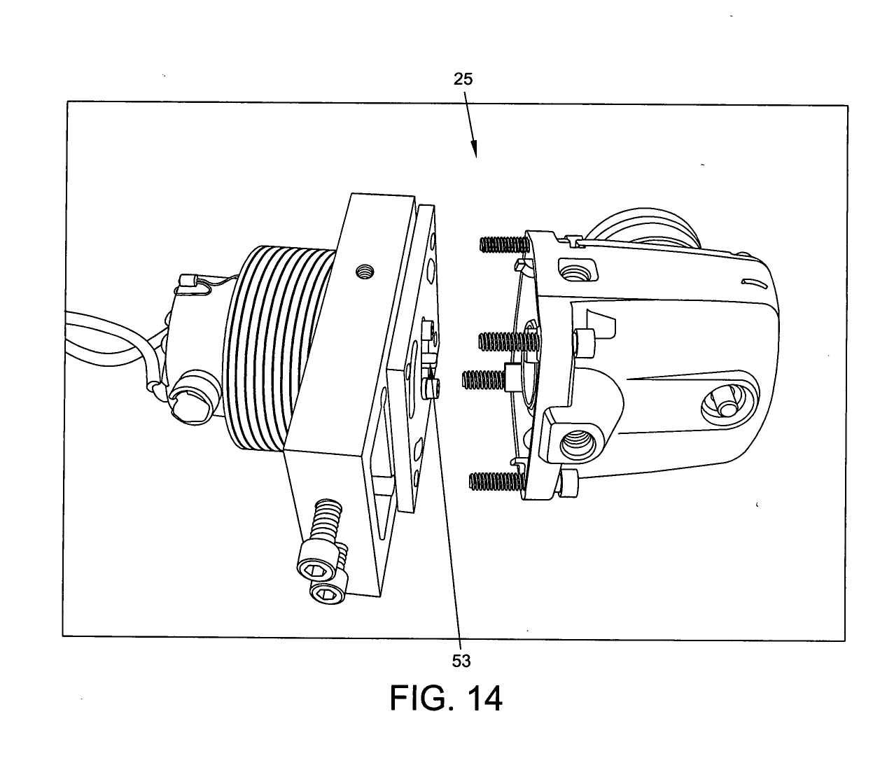

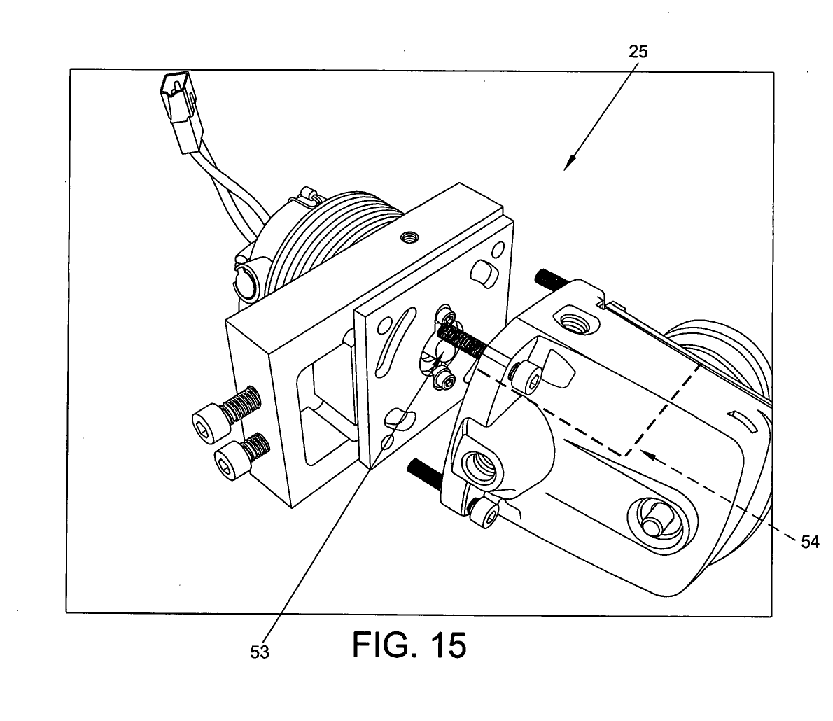

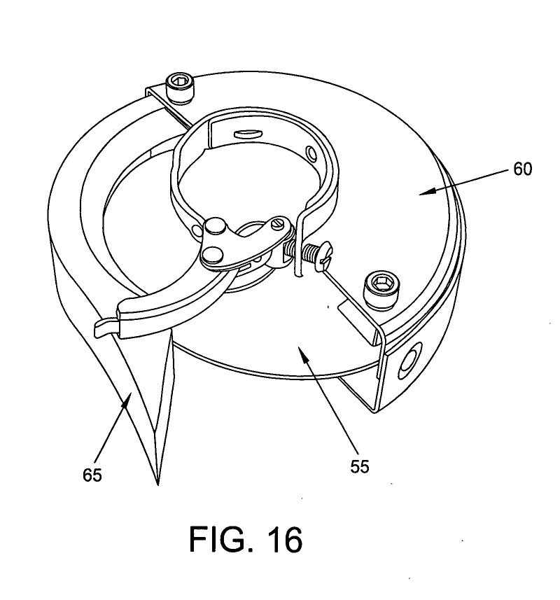

Looking next at FIGS. 4-16, cutter head 25 generally comprises a housing 40 having a mount 45 for connection to, or pick-up by, arm 15 of robot 5 (e.g., by grippers 17 of arm 15). Housing 40 contains an electric motor 50. Electric motor 50 is preferably a DC motor. A grinding wheel 55 is mounted to the drive shaft 53 of motor 50 via a right-angle drive 54 (shown schematically in FIG. 15), such that motor 50 can turn grinding wheel 55. A protective guard 60 is mounted to housing 40 so as to shield a substantial portion of grinding wheel 55 while still leaving another substantial portion of grinding wheel 55 exposed for cutting. A shoe-guide 65 is also mounted to housing 40 so as to prevent harming an adjacent surface when grinding wheel 55 is used to cut an object. By way of example but not limitation, shoe-guide 65 serves to protect the skin of a hostage when grinding wheel 55 is used to cut an explosive package off of the hostage.

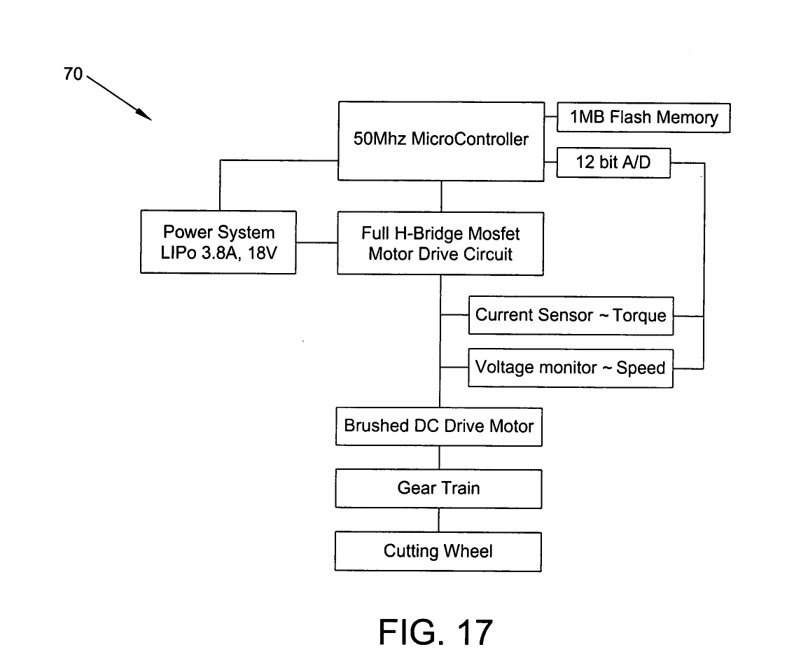

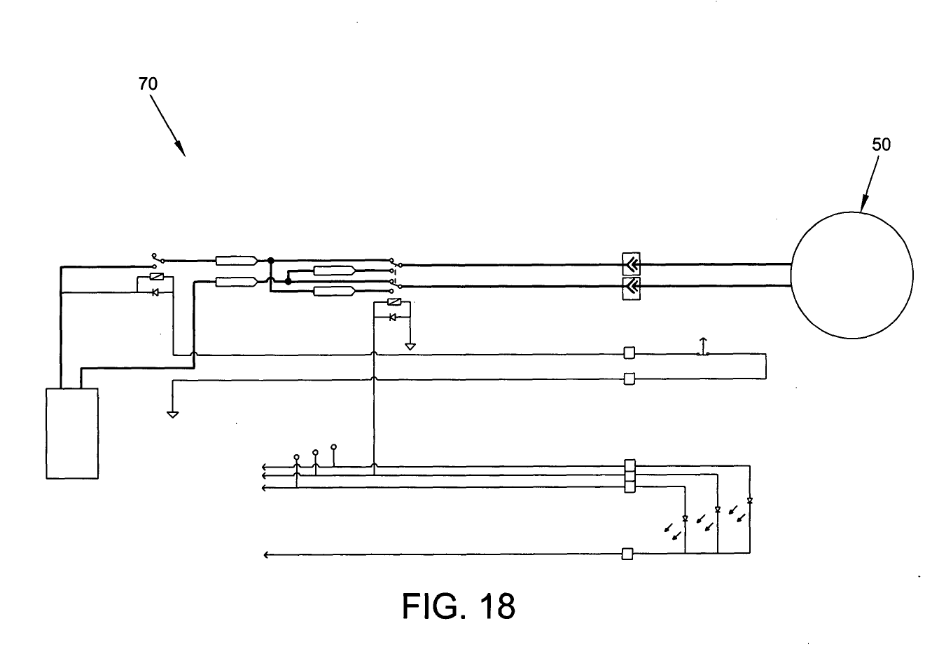

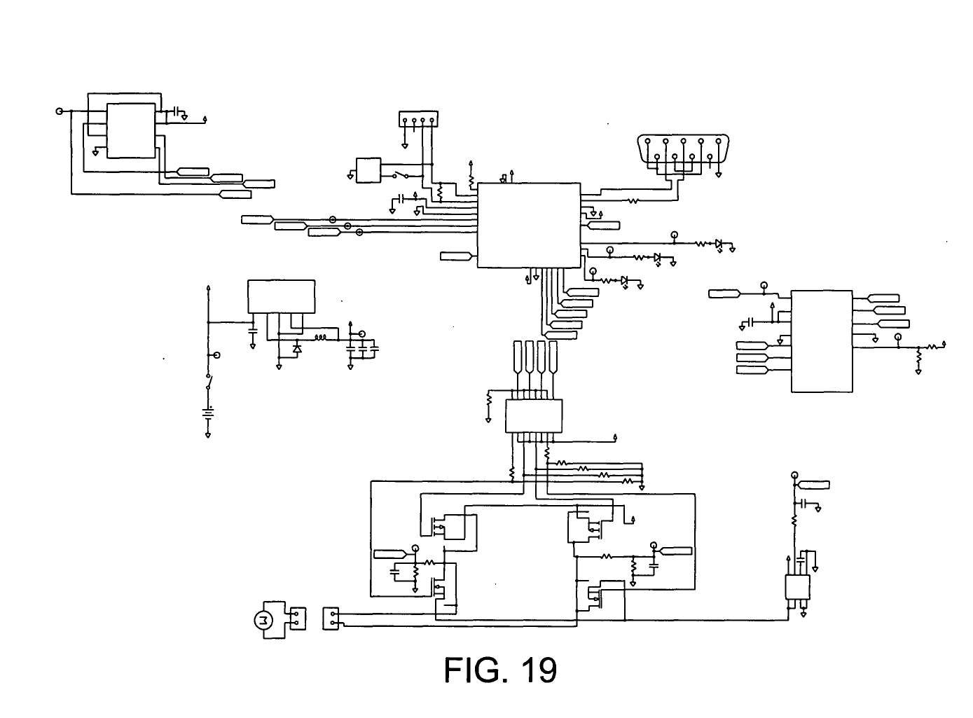

Control electronics 70 (FIGS. 17-19) are interposed between cutter head 25 and power supply 30 and serve to control operation of cutter head 25. Control electronics 60 may be mounted to housing 40 (in which case the control electronics are generally on the distal end of cable 35), or to power supply 30 (in which case the control electronics are generally mounted on the proximal end of cable 35), or they may be otherwise carried by robot 5. Control electronics 70 include an on/off switch 75 for turning universal cutting tool 10 on and off. Preferably on/off switch 75 is a push-type switch, e.g., a bump switch.

Control electronics 70 are adapted to monitor both the speed of motor 50 and the current draw of motor 50 during operation of cutter head 25. Significantly, with the present invention, the speed of motor 50 is monitored by monitoring the back electromotive force (emf) on motor 50. This approach provides a simple and sufficiently accurate means for monitoring the speed of motor 50 without requiring the use of relatively bulky and expensive optical encoder wheels, etc.

More particularly, when a DC motor turns, the coils passing by the armature magnets create a back electromotive force (emf) potential or voltage. This voltage can be correlated to rotational speed. Since the motors have discrete magnets, the back emf is not smooth but very spiky—but by averaging, the voltage (and therefore the motor speed) can be determined. The nice feature about using the back emf to determine motor speed is that no on-board sensors are required, and the wiring at the business end of the motor is simple and unchanged. By comparing the motor driving current with the back emf, the rotational resistance for a given motor can be determined, and it can be used to control how the motor behaves. A DC motor controller is provided which uses a back emf scheme to regulate the motor speed.

The idea is to set thresholds that bound the motor into certain performance envelopes. The lower threshold is the idle condition, and the upper threshold is the stall condition. In the idle condition, the cutter motor turns at very low speed. When the blade encounters an object and the cutting resistance goes up, the motor controller increases the current (and therefore the motor speed) to the level needed for effective cutting.

If the object is force fed into the cutter and the resistance spikes up, the wheel stops, the back emf drops, yet the feed current rises. Under normal conditions this would drain the battery and damage the motor, but by monitoring the unique condition of high current and low back emf (voltage), the motor can be stopped or reversed so as to minimize the potential for jamming.

The principle advantage of the back emf approach is that it is simple, rugged and inexpensive. The disadvantage is that as the motor heats up, the efficiency of creating back emf changes and therefore the thresholds are changing. Also a considerable amount of heat is generated that must be accounted for at both the motor and the control board side. However, these issues are relatively easy to address for the parameters required by the present invention.

With the present invention, control electronics 70 are adapted to operate as follows. When on/off button 75 is pressed, so that universal cutting tool 10 begins to operate, cutter head 25 starts in low speed idle, i.e., with grinding wheel 55 slowly rotating. When grinding wheel 55 is brought into contact with the object which is to be cut, grinding wheel 55 slows down and the current drawn by motor 50 goes up. Control electronics 70 respond by applying more power (either more current or more voltage, or both) to motor 50. If grinding wheel 55 successfully cuts through the object which is to be cut, the load on grinding wheel 55 thereafter drops significantly, thereby causing the speed of motor 50 to jump and the current drawn by motor 50 to drop rapidly. Control electronics 70 sense this rise in motor speed and decline in current draw and respond by causing cutter head 25 to return to its “idle” condition. However, if grinding wheel 55 is not successful in cutting through the object which is to be cut (e.g., because of a jam), the load on grinding wheel 55 rises significantly, causing the speed of motor 50 to drop and the current draw to rise rapidly. Control electronics 70 sense this drop in motor speed and rise in current draw and respond, initially by causing grinding wheel 55 to reverse direction so as to clear the jam or, if this is unsuccessful to clear the jam, by cutting power to motor 50. Universal cutting tool 10 is then retracted from the object which is to be cut (e.g., by withdrawing robot arm 15) and then restarted.

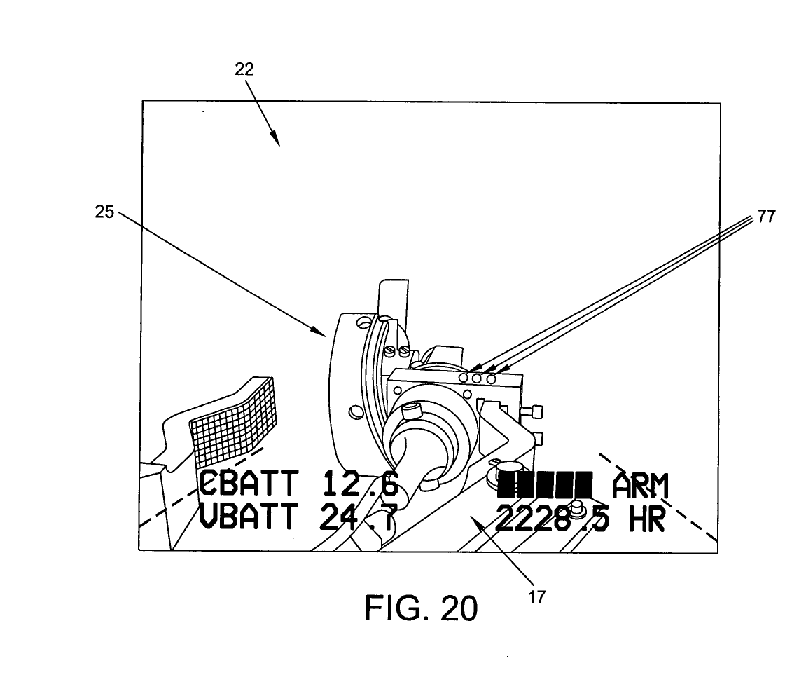

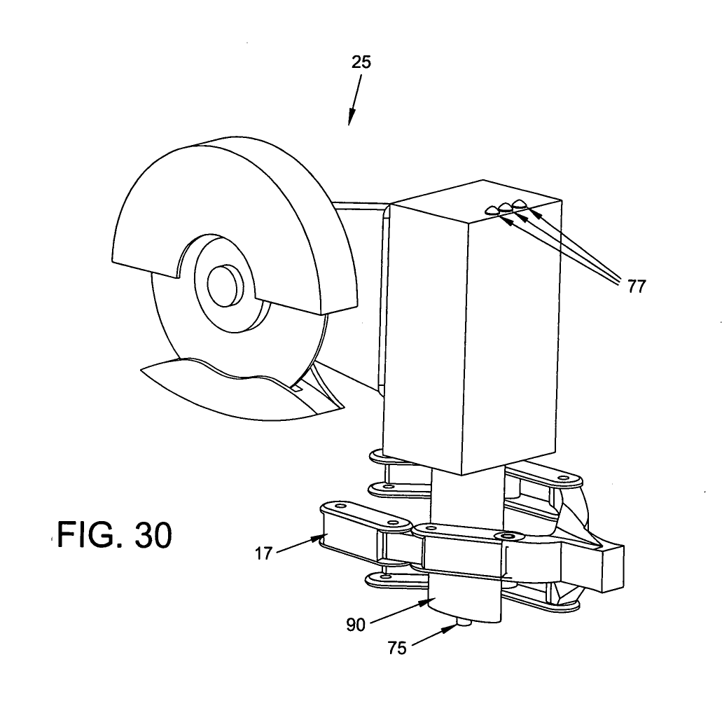

As seen in FIGS. 20, 29 and 30, one or more LED's 77 may be provided on the top of housing 40 (and within the field of view of on-board camera system 18) so as to provide visual feedback to the operator with respect to cutter head operation. By way of example but not limitation, three LED's 77 may be provided: one yellow, one green and one red. These three LED's can then be used to provide the operator with visual feedback with respect to device operation (e.g., a lit yellow LED=idle mode, ready to cut, a lit green LED=cutter head cutting within normal power band, a lit red LED=cutter head operating outside normal power band, etc.).

The following is an exemplary description of the operation and function of universal cutting tool 10.

1. Start. Universal cutting tool 10 is installed onto EOD robot 5. This includes mounting universal cutting tool 10 to arm 15 (e.g., grippers 17) of EOD robot 5, and mounting power supply 30 to the top deck of the robot. The operator verifies that universal cutting tool 10 is powered off.

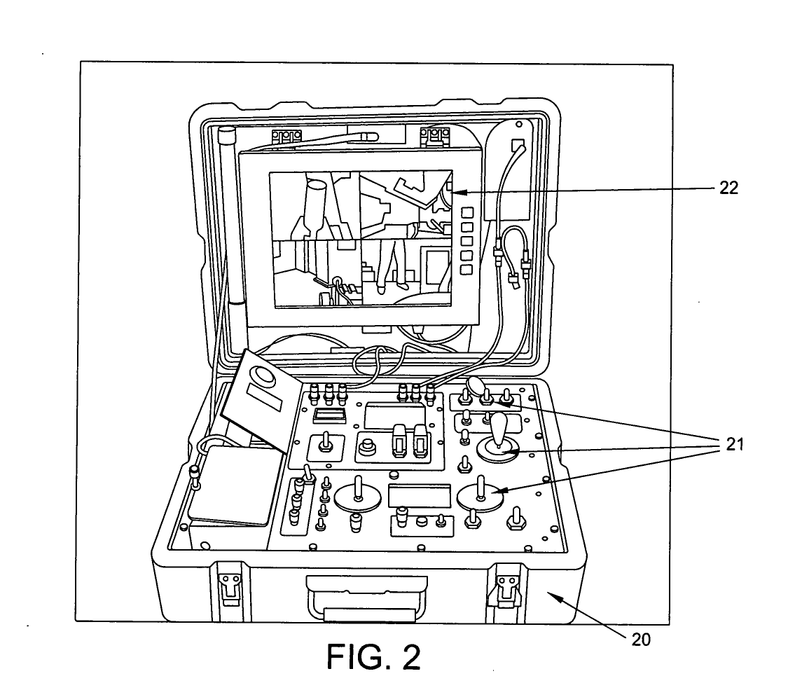

2. Engaging The Object Which Is To Be Cut. Using operator controls 21 and camera display 22 of control panel 20 (FIGS. 2 and 20), the operator advances EOD robot 5 to the site where the object is to be cut by universal cutting tool 10.

3. Turning On Universal Cutting Tool 10. Still looking through the robot's camera display, the operator manipulates arm 15 of EOD robot 5 so that on/off switch 75 (located on cutter head 25) is momentarily engaged and the tool is turned on. Preferably, a yellow idle LED illuminates, indicating that the tool is powered on and is in its idle (i.e., unloaded) state.

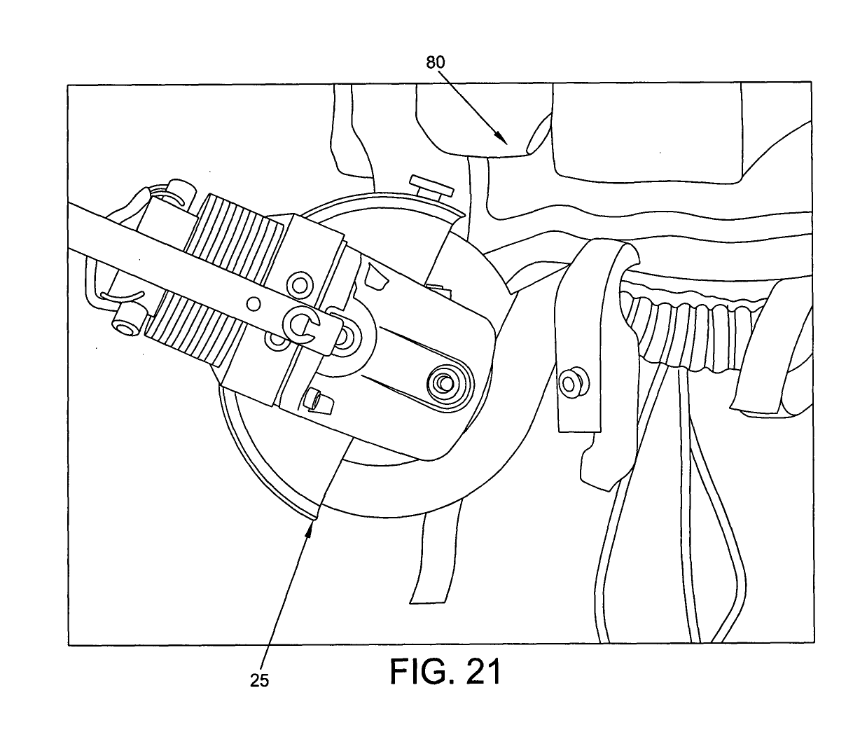

4. Cutting. The operator manipulates cutter head 25 of universal cutting tool 10 so that grinding wheel 55 engages the object which is to be cut (FIG. 21) and applies pressure. Control electronics 70 sense the change in the load on motor 50 and respond by increasing the power applied to the motor. As power is increased, the motor's rpm increases and grinding wheel 55 begins to cut through the object. When this occurs, the yellow LED extinguishes and the green LED illuminates, indicating that the tool is operating within its normal power band. Should the cutting process result in an overload which exceeds the allowed power band of the tool, the green LED will extinguish and the red LED illuminates, signaling the operator to lessen the pressure on the cutter. Should the overload cause the cutter to jam, control electronics 70 will cause motor 50 to automatically reverse direction in order to help free the jam. The operator continues to apply pressure to the object being cut until it is observed that the cutting process is complete.

5. Storing The Universal Cutting Tool. Once the cutting process is complete, the operator uses the robot's arm 15 to move cutter head 25 away from the object which has been cut. The operator can then maneuver arm 15 so as to cause cutting head 25 to engage another object to be cut, or to turn the cutting head off by again momentarily engaging power on/off switch 75.

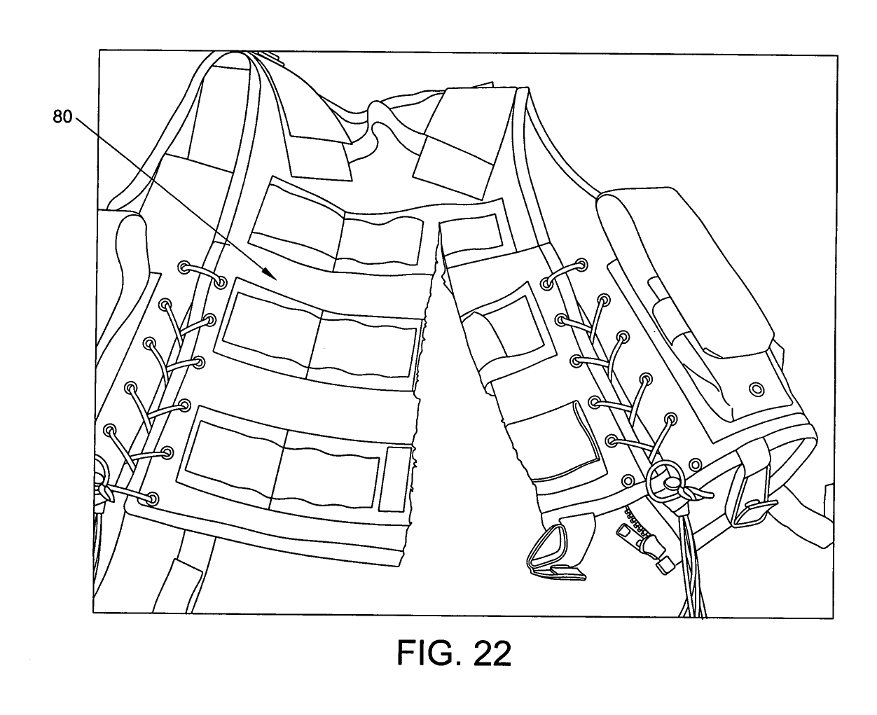

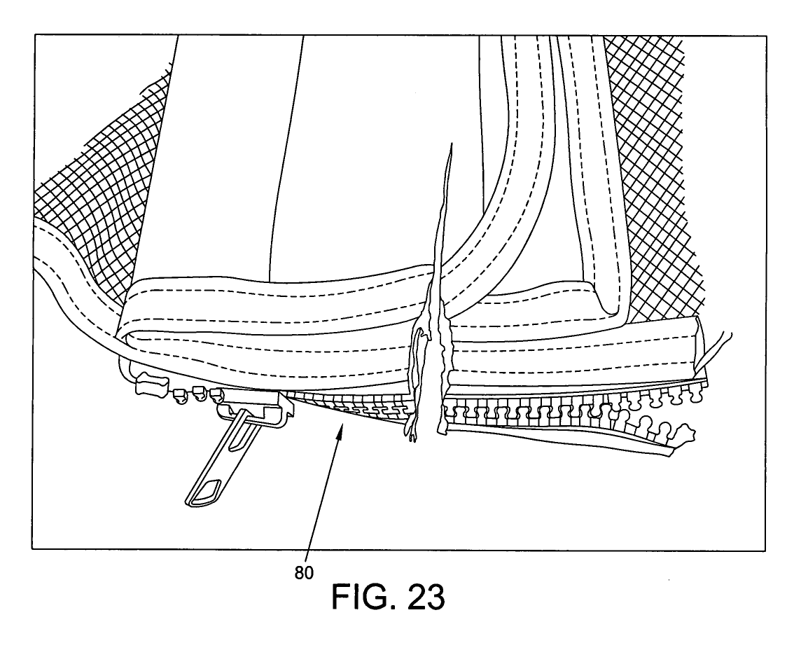

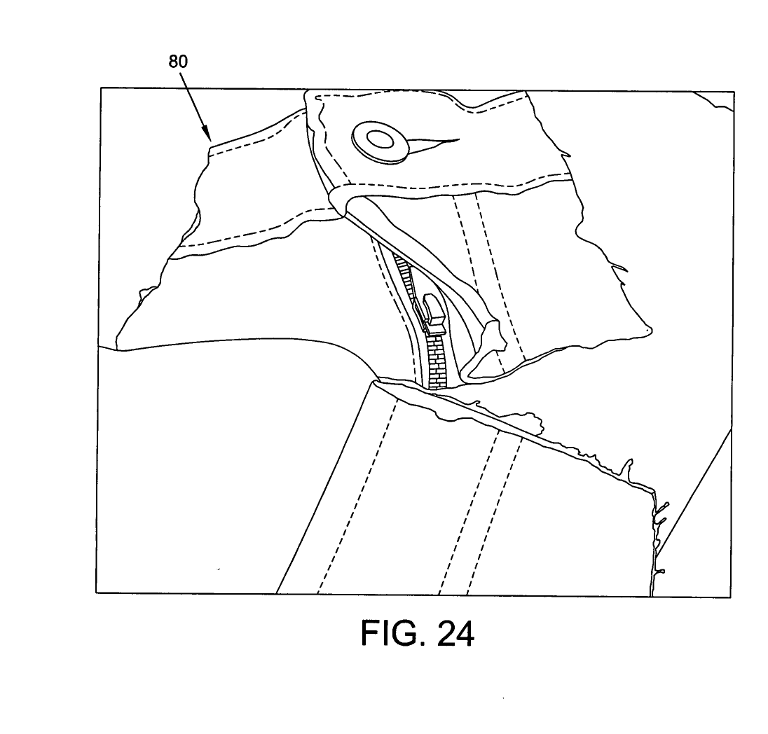

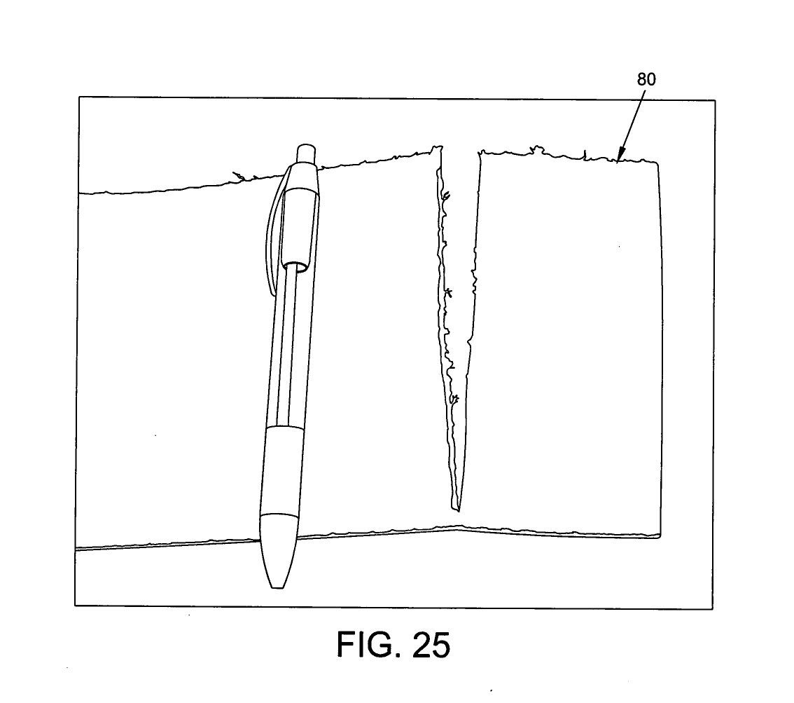

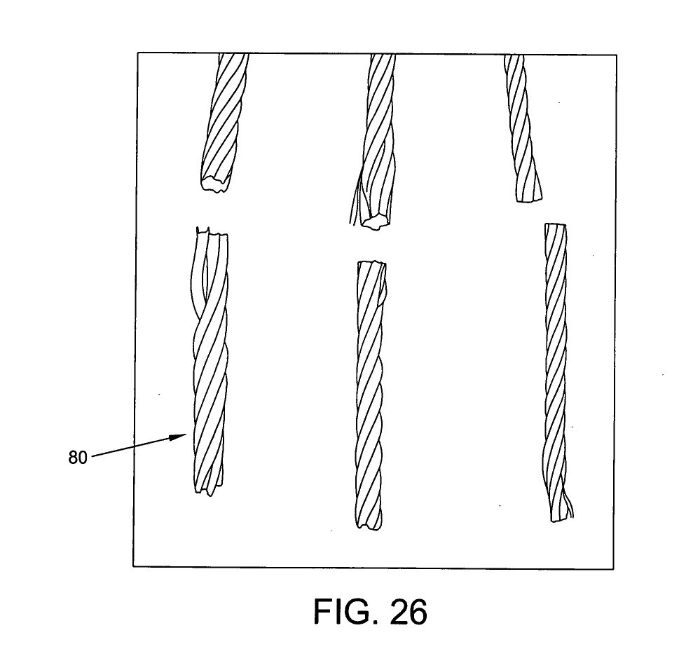

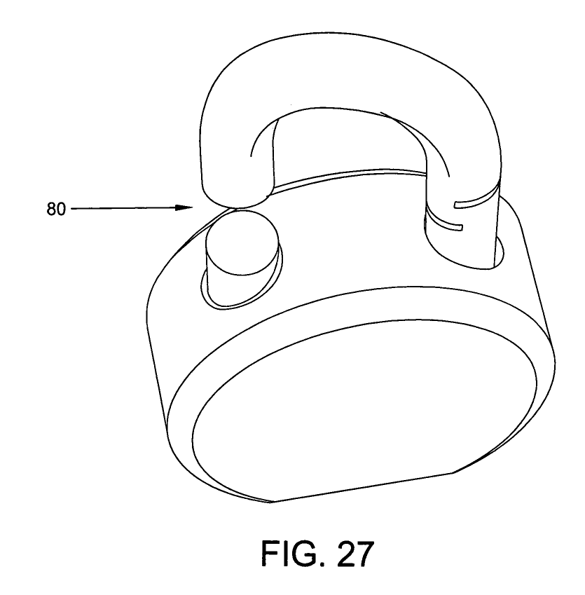

By using a grinding wheel 55 as the cutting element for cutter head 25, a much wider range of objects can be cut than if the cutting element were a single blade, or shears, or a saw, etc. By way of example but not limitation, grinding wheel 55 can be used to cut cloth, ballistic nylons, mixed textiles with zippers, buckles or chain, key shanks, cable, chain, sheet metal, etc. See FIGS. 22-27, which illustrate just some (but not all) of the objects 80 which can be successfully cut by cutter head 25.

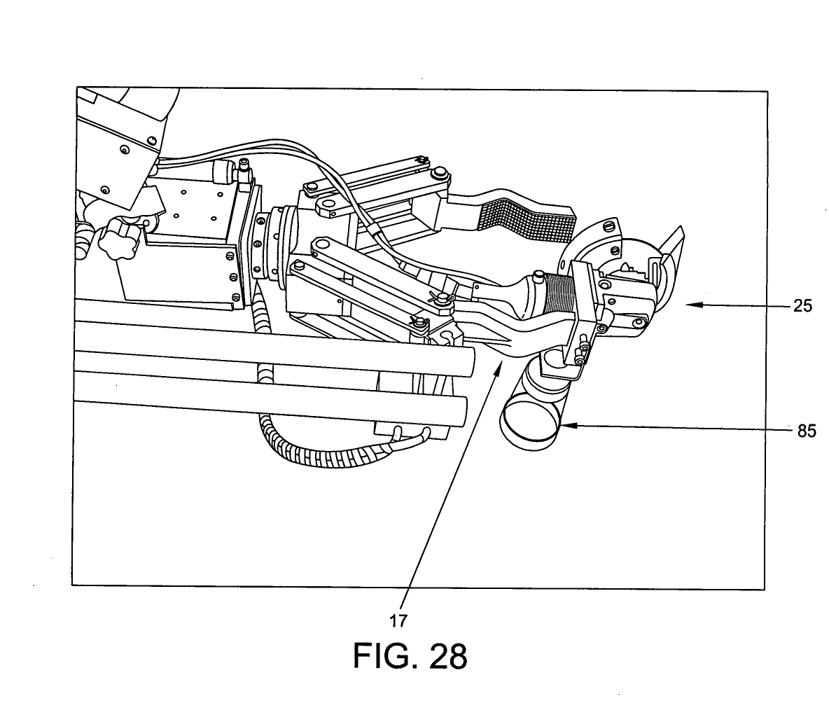

If desired, and looking now at FIG. 28, in many situations it may be desirable to operate power on/off switch 75 as a bump switch. In this case, it can be helpful to provide an extension 85 (e.g., in the form of a projecting ring or rod) for the switch, so as to facilitate bump actuation, e.g., against the ground.

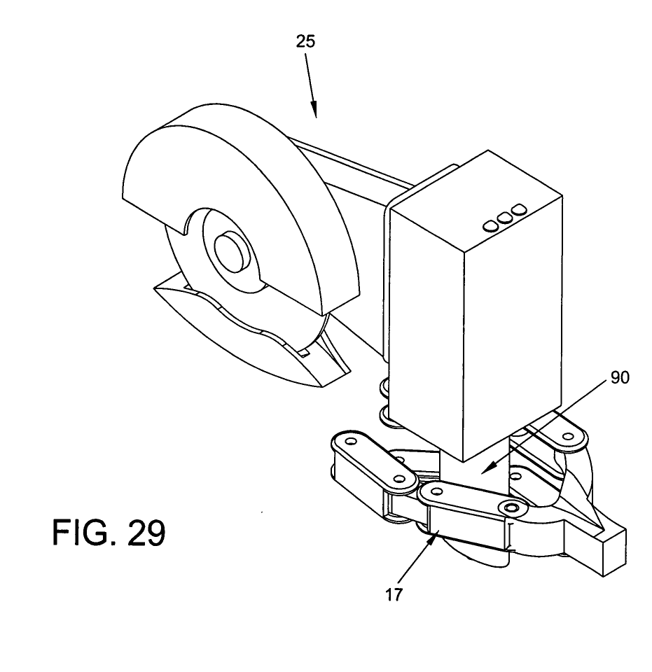

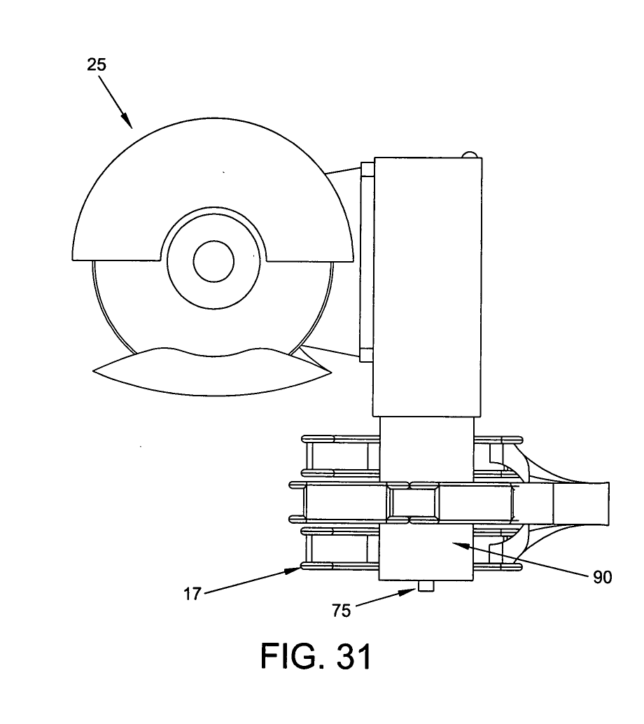

Furthermore, it may be desirable to provide cutter head 25 with a pistol grip, so as to facilitate pick-up and drop-off of the cutter head by robot arm 15 (e.g., by grippers 17 of robot arm 15). Thus, and looking now at FIGS. 29-31, cutter head 25 may be provided with a pistol grip 90, with power on/off “bump” switch 75 positioned at the heel of the pistol grip. In this respect it should be appreciated that where cutter head 25 is provided with a pistol grip, it can be desirable to provide EOD robot 5 with a carrying bin (not shown), so that the cutter head 25 can be placed in the carrying bin at the outset of the mission and then be replaced back into the carrying bin at the conclusion of the cutting operation, thereby freeing up the robot arm for other tasks when cutting is not being performed.

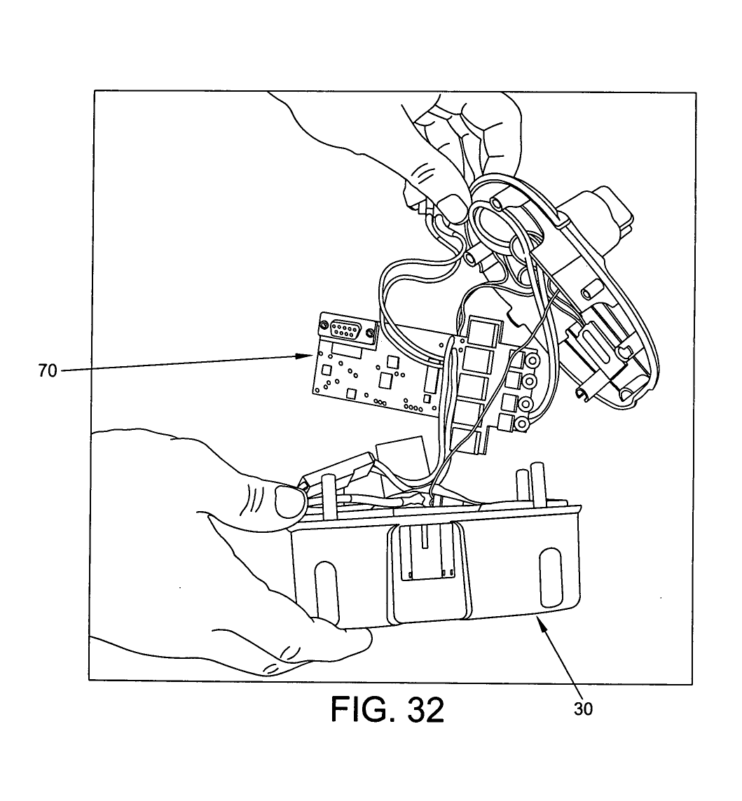

As noted above, power supply 30 is preferably mounted to the chassis of EOD robot 5 in order to improve arm balance and permit larger (and hence heavier) batteries to be carried for the mission. However, in some cases it may be desirable to mount power supply 30 directly to housing 40 of cutter head 25. In this circumstance, it may also be desirable to mount control electronics 70 to power supply 30, e.g., such as is shown in FIG. 32.

Significantly, due to its design, universal cutting tool 10 can be used with both legacy EOD robots as well as with new generation EOD robots. In fact, universal cutting tool 10 can be used with substantially any robot, or it can even be used as a hand tool independent of a robot.

### Modifications of the Preferred Embodiments

It should be understood that many additional changes in the details, materials, steps and arrangements of parts, which have been herein described and illustrated in order to explain the nature of the present invention, may be made by those skilled in the art while still remaining within the principles and scope of the invention.

What is claimed is:

1. A universal cutting tool for use on the arm of a robot, the universal cutting tool comprising:
a cutter head comprising a housing adapted for attachment to the arm of a robot, an electric motor secured to the housing and comprising a drive shaft, and a grinding wheel connected to the drive shaft;
a power supply; and
control electronics for operating the electric motor, the control electronics connecting the power supply to the motor;
the control electronics comprising a bump switch for turning the electric motor on and off.

2. A universal cutting tool according to claim 1 wherein the bump switch is disposed on the housing.

3. A universal cutting tool according to claim 2 wherein the bump switch comprises an activation element substantially displaced from the housing.

4. A universal cutting tool for use on the arm of a robot, the universal cutting tool comprising:
a cutter head comprising a housing adapted for attachment to the arm of a robot, an electric motor secured to the housing and comprising a drive shaft, and a grinding wheel connected to the drive shaft;
a power supply; and
control electronics for operating the electric motor, the control electronics connecting the power supply to the motor;
the housing comprising a pistol grip adapted to be gripped by the arm of the robot.

5. A universal cutting tool according to claim 4 wherein the control electronics comprise a bump switch for turning the electric motor on and off, and further wherein the bump switch is disposed on the heel of pistol grip.

6. A universal cutting tool for use on the arm of a robot, the universal cutting tool comprising:
a cutter head comprising a housing adapted for attachment to the arm of a robot, an electric motor secured to the housing and comprising a drive shaft, and a grinding wheel connected to the drive shaft;
a power supply; and
control electronics for operating the electric motor, the control electronics connecting the power supply to the motor;
the cutter head further comprising a shoe-guide disposed adjacent to, but displaced from, at least a portion of the periphery of the grinding wheel so as to protect an adjacent surface while the grinding wheel is cutting an object.

7. A universal cutting tool according to claim 6 wherein the displacement of the shoe-guide from the periphery of the grinding wheel is adjustable.

8. A universal cutting tool for use on the arm of a robot, the universal cutting tool comprising:
a cutter head comprising a housing adapted for attachment to the arm of a robot, an electric motor secured to the housing and comprising a drive shaft, and a grinding wheel connected to the drive shaft;
a power supply; and
control electronics for operating the electric motor, the control electronics connecting the power supply to the motor;
the control electronics comprising at least one visual indicator mounted to the housing for visually advising the robot operator of the operating status of the cutter head.

9. A universal cutting tool according to claim 8 wherein the at least one visual indicator comprises an LED.

10. A universal cutting tool for use on the arm of a robot, the universal cutting tool comprising:
a cutter head comprising a housing adapted for attachment to the arm of a robot, an electric motor secured to the housing and comprising a drive shaft, and a grinding wheel connected to the drive shaft;
a power supply; and
control electronics for operating the electric motor, the control electronics connecting the power supply to the motor;
wherein the power supply is separate from the robot power supply and further wherein the control electronics are separate from robot control electronics.

11. A universal cutting tool for use on the arm of a robot, the universal cutting tool comprising:
a cutter head comprising a housing adapted for attachment to the arm of a robot, an electric motor secured to the housing and comprising a drive shaft, and a grinding wheel connected to the drive shaft;
a power supply; and
control electronics for operating the electric motor, the control electronics connecting the power supply to the motor;
wherein the control electronics are adapted to monitor the level of current drawn by the electric motor and to monitor the speed of rotation of the drive shaft.

12. A universal cutting tool according to claim 11 wherein the control electronics monitor the speed of the drive shaft by monitoring the back EMF of the electric motor.

13. A method for cutting an object, the method comprising:
providing a universal cutting tool for use on the arm of a robot, the universal cutting tool comprising:
a cutter head comprising a housing adapted for attachment to the arm of a robot, an electric motor secured to the housing and comprising a drive shaft, and a grinding wheel connected to the drive shaft;
a power supply; and
control electronics for operating the electric motor, the control electronics connecting the power supply to the motor;
wherein the control electronics are adapted to monitor the level of current drawn by the electric motor and to monitor the speed of rotation of the drive shaft;
mounting the cutter head to the arm of the robot;
operating the electric motor in idle mode so that the drive shaft has a slow rate of revolution;
engaging the object which is to be cut with the grinding wheel;
when the rate of rotation of the grinding wheel falls and the current draw on the motor rises, raising the power applied to the electric motor so that the motor's revolutions per minute increases;
if and when the level of power being drawn exceeds a predetermined level, providing an alert to an operator; and
if and when the revolutions per minute of the motor thereafter stops, reversing the direction of the motor.
